(19) United States
(12) Patent Application Publication
(10) Pub. No.: US 2025/0247798 A1
(43) Pub. Date: Jul. 31, 2025

(54) EIRP MASK SPECIFICATIONS WITH SUBARRAY ANTENNA ARCHITECTURES

(71) Applicant: QUALCOMM Incorporated, San Diego, CA (US)

(72) Inventors: Vasanthan RAGHAVAN, West Windsor Township, NJ (US); Mustafa EMARA, Munich (DE); Marco PAPALEO, Bologna (IT); Michael Alexander RUDER, Pommelsbrunn (DE)

(21) Appl. No.: 18/427,440

(22) Filed: Jan. 30, 2024

(51) Int. Cl. H04W 52/36; H04B 7/06; H04B 17/10

(52) U.S. Cl. CPC H04W 52/367; H04B 7/0617; H04B 17/102

(57) ABSTRACT

Method and apparatus for EIRP mask specifications with subarray antenna architectures. The apparatus selects at least one transmission configuration parameter of an antenna array based on an EIRP threshold including one or more of an average EIRP over multiple subarray architecture parameters or a maximum EIRP for each of the multiple subarray architecture parameters. The apparatus transmits based on the at least one transmission configuration parameter. The apparatus may measure at least one of the average EIRP or the maximum EIRP based on the selected at least one transmission configuration parameters. The apparatus may compare the selected at least one transmission configuration parameters with a configured set of acceptable parameters or non-acceptable parameters.

### TECHNICAL FIELD

The present disclosure relates generally to communication systems, and more particularly, to a configuration for equivalent isotropic radiated power (EIRP) mask properties for a device based on subarray antenna architectures implemented at the device.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some instances, emissions from terrestrial cellular network nodes or entities may interfere with existing services/operations (e.g., airplane radio altimeters, satellite services), despite the presence of a gap within the respective operational frequency ranges of the cellular network nodes/entities and the existing services/operations. This interference may lead to safety issues or poor performance of the existing services/operations (e.g., airplane radio altimeters, satellite services). The disclosure provides aspects directed to minimize or reduce interference to the existing services/operations due to emissions from terrestrial cellular network nodes or entities.

In an aspect of the disclosure, a method, a computer-readable medium, and an apparatus are provided. The apparatus may be a device at a first network node. The device may be a processor and/or a modem at a first network node or the first network node itself. The apparatus selects at least one transmission configuration parameter of an antenna array based on an equivalent isotropic radiated power (EIRP) threshold including one or more of an average EIRP over multiple subarray architecture parameters or a maximum EIRP for each of the multiple subarray architecture parameters. The apparatus transmits based on the at least one transmission configuration parameter.

In an aspect of the disclosure, a method, a computer-readable medium, and an apparatus are provided. The apparatus may be a device at a second network node. The device may be a processor and/or a modem at a second network node or the second network node itself. The apparatus provides, to a first network entity, an equivalent isotropic radiated power (EIRP) threshold including one or more of an average EIRP over multiple subarray architecture parameters or a maximum EIRP for each of the multiple subarray architecture parameters. The apparatus measures at least one of an average EIRP or a maximum EIRP based on the selected at least one transmission configuration parameters.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of an EIRP mask.

FIG. 5 is a diagram illustrating an example of an antenna subarray.

FIG. 6A is a diagram illustrating an example of an expected transmission performance of a network entity.

FIG. 6B is a diagram illustrating an example of an actual transmission performance of a network entity.

FIG. 7 is a diagram illustrating an example of an EIRP mask based on an antenna array architecture of a network entity.

FIG. 8 is a call flow diagram of signaling between a first network entity and a second network entity.

FIG. 9 is a flowchart of a method of wireless communication.

FIG. 10 is a flowchart of a method of wireless communication.

FIG. 11 is a diagram illustrating an example of a hardware implementation for an example network entity.

FIG. 12 is a flowchart of a method of wireless communication.

FIG. 13 is a diagram illustrating an example of a hardware implementation for an example network entity.

### DETAILED DESCRIPTION

In wireless communications, issues may exist in some frequency bands with airplane radio altimeters (RAs) operating in some frequency ranges and cellular services. In some instances, leakage of radiation from cellular to RAs may lead to safety issues and poor performance of RAs. Similar coexistence issues between RAs or other devices and cellular services may occur at millimeter wave carrier frequencies that use large antenna arrays. As carrier frequency increases, more antennas may be used in FR4 and/or FR5 at both the network entities and UEs. In addition, a new set of infrastructure nodes (e.g., repeaters, relays, intelligent reflective surface (IRS) nodes, IAB nodes, etc.) may be considered as networks become hyper-densified. As such, interference generated by these nodes to existing services/operations may result in compliance issues. Interference to coexisting services may be problematic for frequency ranges (e.g., FR2 and future FR3 spectrum allocations), such that solutions to minimize emissions from terrestrial network entities above a reference plane (e.g., above the horizon) are desirable.

Aspects presented herein provide a configuration for EIRP mask or threshold properties based on subarray antenna architectures. The EIRP mask properties may address unintended interference of an aggressor node having a subarray antenna architecture.

EIRP is a measurement of radiated output power of a transmitter in a single direction. EIRP may be based on the transmitted power and the antenna gain, and may indicate the amount of power an isotropic antenna would need to radiate to achieve an equivalent signal strength as a beam antenna.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

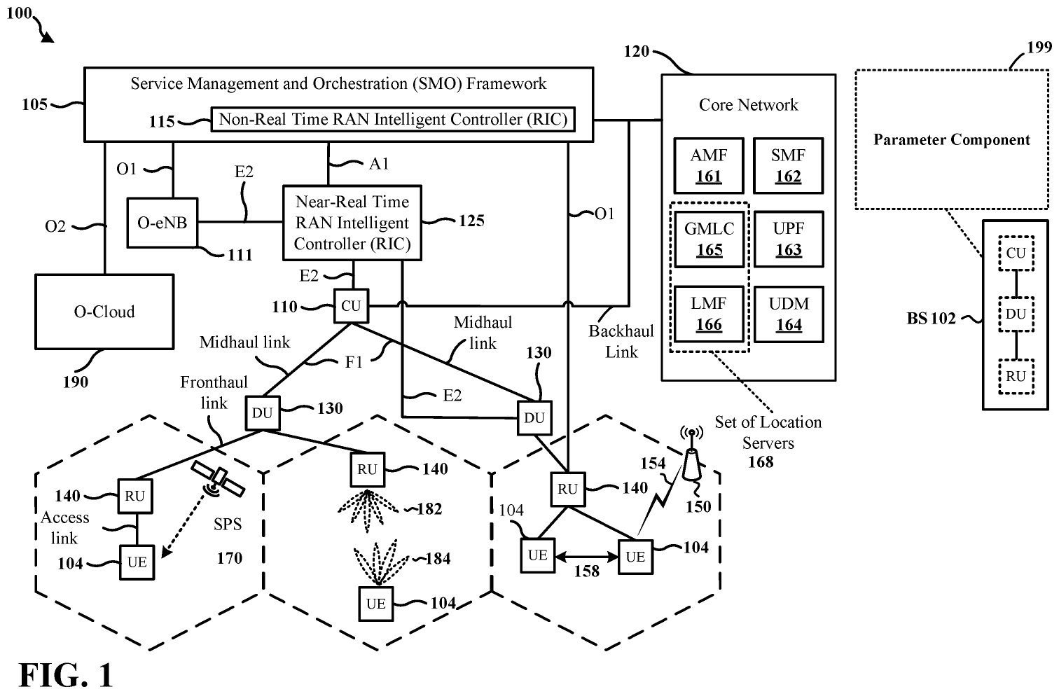

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface).

Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may comprise a parameter component 199 that may be configured to select at least one transmission configuration parameter of an antenna array based on an EIRP threshold including one or more of an average EIRP over multiple subarray architecture parameters or a maximum EIRP for each of the multiple subarray architecture parameters; and transmit based on the at least one transmission configuration parameter. In some aspects, the parameter component 199 may be configured to provide, to a first network entity, an EIRP threshold including one or more of an average EIRP over multiple subarray architecture parameters or a maximum EIRP for each of the multiple subarray architecture parameters; and measure at least one of an average EIRP or a maximum EIRP based on the selected at least one transmission configuration parameters.

Although the following description may be focused on 5G NR, the concepts described herein may be applicable to other similar areas, such as LTE, LTE-A, CDMA, GSM, and other wireless technologies.

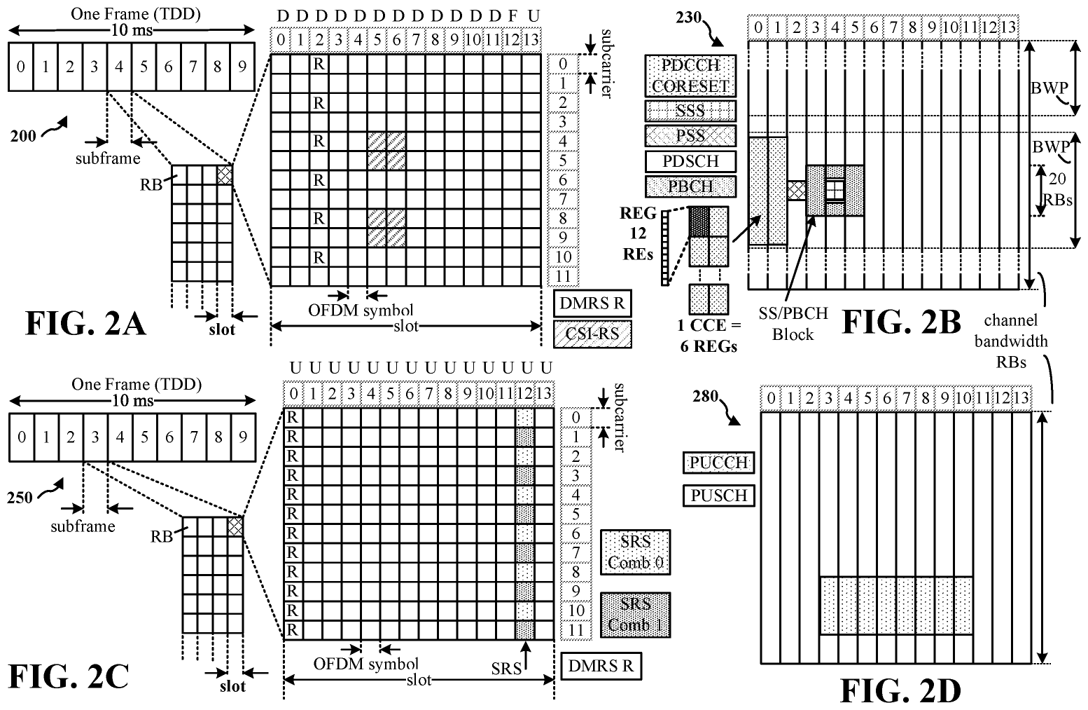

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

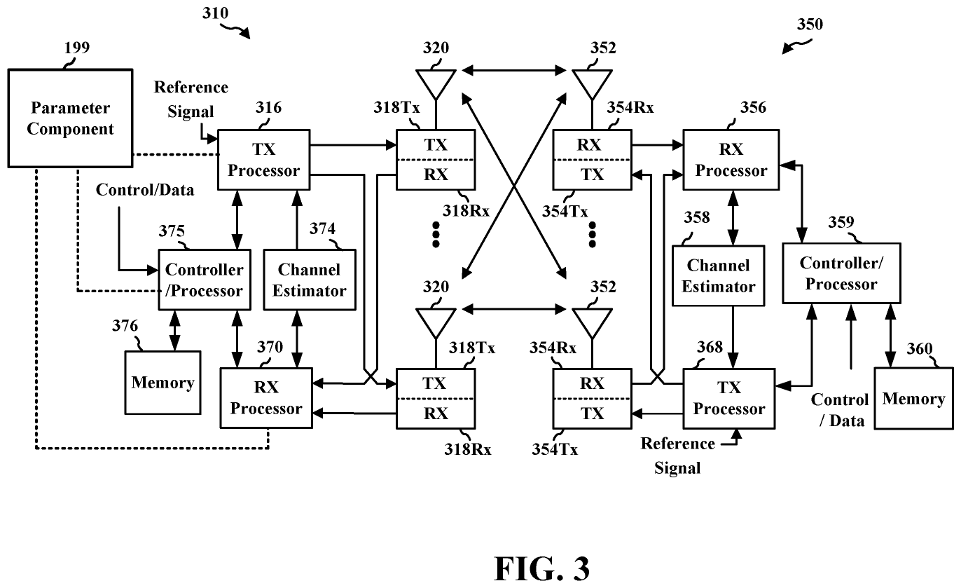

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the parameter component 199 of FIG. 1.

In wireless communications, issues may exist in some frequency bands (e.g., C-band) with airplane radio altimeters (RAs) operating in some frequency ranges (e.g., 4.2-4.4 GHz range) and cellular services (e.g., operating in 3.98 GHz) in some geographies (e.g., United States). In some instances, leakage of radiation from cellular to RAs may lead to safety issues and poor performance of RAs. Spectrum sharing between terrestrial and satellite services may be utilized for 6G deployment, especially for intermediate frequencies, such as but not limited to FR3 between 7.125-24.25 GHz. Similar coexistence issues between RAs or other devices and cellular services may occur at millimeter wave carrier frequencies that use large antenna arrays (e.g., greater than or equal to 64 antenna elements at the network entity).

As carrier frequency increases, more antennas may be used in FR4 and/or FR5 at both the network entities and UEs. In addition, a new set of infrastructure nodes (e.g., repeaters, relays, intelligent reflective surface (IRS) nodes, IAB nodes, etc.) may be considered as networks become hyper-densified. As such, interference generated by these nodes to existing services/operations may result in compliance issues. Interference to coexisting services may be problematic for frequency ranges (e.g., FR2 and future FR3 spectrum allocations), such that solutions to minimize emissions from terrestrial network entities above a reference plane (e.g., above the horizon) are desirable.

Aspects presented herein provide a configuration for EIRP mask properties based on subarray antenna architectures. The EIRP mask properties may address unintended interference of an aggressor node having a subarray antenna architecture. At least one advantage of the disclosure is that the EIRP mask properties may mitigate interference of aggressor nodes based in part on subarray architecture parameters.

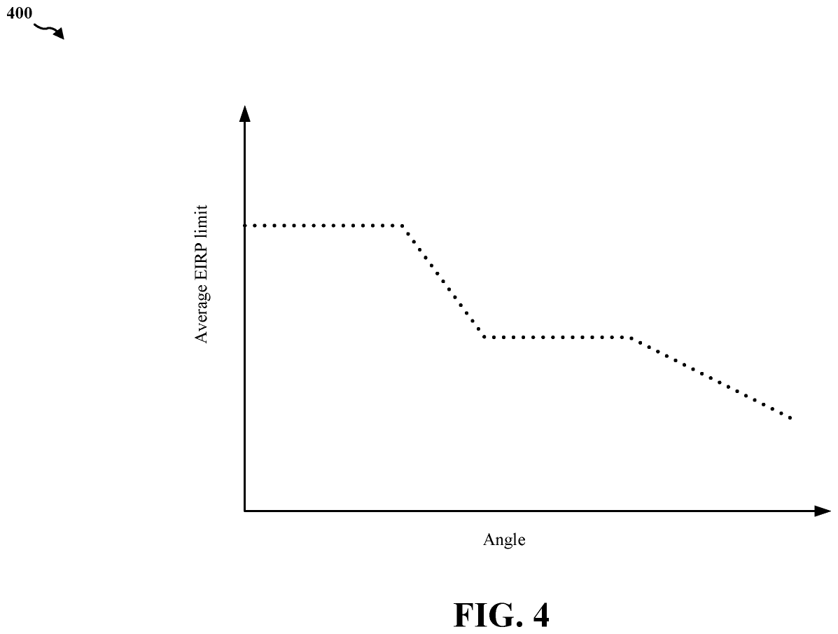

FIG. 4 is a diagram 400 of an example of an EIRP mask. The mask of diagram 400 may provide a maximum and/or average permissible EIRP level over a specific angle (e.g., elevation angle) and an aggressor node is expected to transmit within the prescribed specifications. When transmission power from an aggressor node is below the specifications, interference at victim nodes is minimized.

The mean EIRP at a specific elevation (vertical) angle θ₀ may be measured by measuring the values of EIRP P (in mW/MHz) towards the elevation θ₀ and at N distinct azimuth (horizontal) angles φₙ uniformly or non-uniformly spaced between −180° and +180° and K beamforming directions by subsequently performing a weighted average of the measured EIRP values. The mean EIRP may be represented as follows:

$$\overline{P} ( {θ}_{0} ) = \frac{1}{K N} {Σ}_{k = 1}^{K} {Σ}_{n = 1}^{N} {w}_{n , k} , P ( {θ}_{0} , {φ}_{n} , {θ}_{T L , k} , {φ}_{S C , k} )$$

where the number N of azimuth angles at which EIRP should be measured and averaged, and the values of elevation angle θ₀ for which means EIRPs should be calculated. The value N should be chosen to provide a sufficiently accurate averaging while avoiding prohibitive numbers of measurements, while an appropriate set of elevation angles could be specified in order to conform compliance with the limits set out in the technical conditions. The operational parameters of the base station (e.g., beamforming directions) should be specified in order to provide for reliable measurements.

Active antenna system (AAS) modeling for FR2 may implicitly assume analog beamforming over a planar array. An alternate approach or model based on subarray/panel based AAS may be considered. The disclosure may provide a hybrid beamforming and a more realistic base station deployment. AAS may utilize antennas based on several identical radiating elements located in a planar array configuration with fixed separated distances. A total antenna gain is the sum of the array gain and the element gain, and a model accuracy may be dependent upon the parameter values.

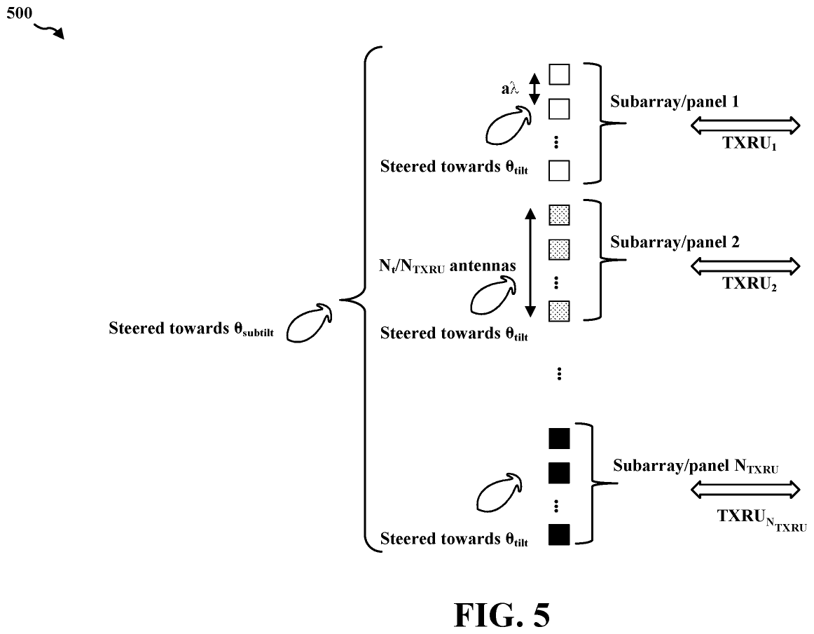

FIG. 5 is a diagram 500 illustrating an example of an antenna subarray. The diagram 500 provides a case where Nₜ antennas in an elevation domain, having a linear array of Nₜ×1, are partitioned into N_{TXRU} groups with N/N_{TXRU} antennas per group. Each antenna group may form a subarray panel (e.g., subarray/panel 1, 2, . . . . N_{TXRU}). The inter-antenna element spacing may be aλ where a≥0.5. A steering angle of antenna elements within each subarray/panel is θₜᵢₗₜ, and a steering angle across subarrays is θ_{subtilt}, where θₜᵢₗₜ≠θ_{subtilt}.

An impact of the subarrays on the EIRP emissions to satellites may be observed. The sensitivity of the emissions may be based on the number of deployed subarray elements. Compared to systems with no vertical subarrays deployed, fluctuations on the EIRP emissions perceived by incumbent satellites may be observed in the vertical domain. In some instances, the array may comprise N elements in the horizontal plane and M sub-arrays in the vertical plane. Each sub-array of the M sub-arrays may comprise M_{sub} elements in the vertical domain. The following equations may include some working assumptions:

$${P}_{Tx - sub} [ dBm ] = {P}_{conducted per element} [ dBm ] + 10 * {log}_{10} ( {N}_{s u b} )$$

$${P}_{T x} [ dBm ] = {P}_{Tx - sub} [ dBm ] + 10 * {log}_{10} ( M * N )$$

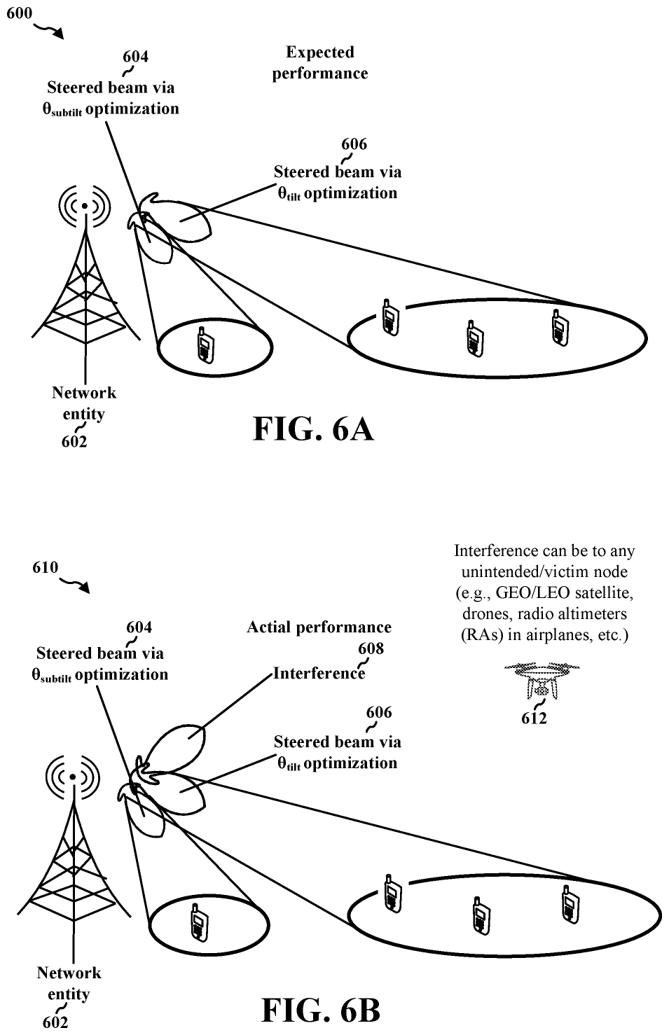

FIGS. 6A and 6B are diagrams 600, 610 that provide an example of expected transmission performance and an actual transmission performance, respectively. In diagram 600 of FIG. 6A, the network entity 602 may have an expected performance of a steered beam 604 and a steered beam 606. The steered beam 604 may be steered via θ_{subtilt} optimization, and the steered beam 606 may be steered via θₜᵢₗₜ optimization. The steered beam 604 may be intended to provide coverage or transmissions to UEs within a beam pattern or region that is within a near or close proximity to the network entity. The steered beam 606 may be intended to provide coverage or transmissions to UEs within a beam pattern or region that is distanced or far from the network entity.

In diagram 610 of FIG. 6B, the network entity 602 has an actual performance of the steered beam 604, 606, and also that of interference 608. The interference 608 may be to any unintended or victim node 612, such as but not limited to satellites, drones, RAs, or the like. Interference caused to other incumbent systems may occur at different angles and may depend on the AAS and subarray parameters.

In some instances, EIRP above the horizon or a reference plane, at different angles, is a function of different AAS architecture parameters (e.g., number of TXRUs, tilt angles, inter-antenna element spacings, array dimensions, etc.). These parameters may be implemented at the network entity but may not be optimized once deployed.

A threshold for an average and/or worst case EIRP (e.g., EIRP_{avg,allowed}(θ₀) and EIRP_{max,allowed}(θ₀)) may be predetermined, where the average/worst case EIRP is over all possible AAS architecture parameters. The average EIRP at an angle θ₀ over AAS architecture parameters is denoted as EIRP_{avg}(θ₀) and may be represented by the following equation:

$${EIRP}_{a v g} ( {θ}_{0} ) = \frac{1}{N K L} {\sum }_{ℓ = 1}^{L} {\sum }_{k = 1}^{K} {\sum }_{n = 1}^{N} {w}_{n , k , ℓ} \cdot P ( {θ}_{0} , {∅}_{n} , {w}_{k} , {SA}_{ℓ} )$$

where [symbol] is a weighting factor capturing the likelihood of usage, Øₙ is an azimuth sampling angle, wₖ is a sample single beamspace peak or multi-beam beamforming vectors, and [symbol] is a subarray architecture parameters (e.g., number of subarrays, electrical subarray tilting angles, etc.). The worst case EIRP over AAS architecture parameters is denoted as EIRPₘₐₓ(θ₀) and may be represented by the following equation:

$${EIRP}_{max} ( {θ}_{0} ) = \frac{1}{N K} {max}_{ℓ = 1 , … , L} {\sum }_{k = 1}^{K} {\sum }_{n = 1}^{N} {w}_{n , k} \cdot P ( {θ}_{0} , {∅}_{n} , {w}_{k} , {SA}_{ℓ} )$$

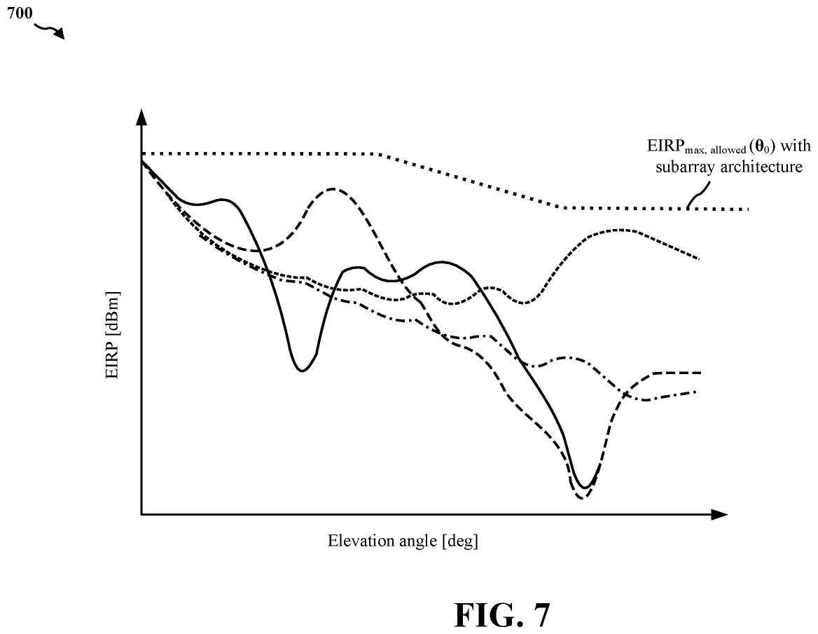

FIG. 7 is a diagram 700 of an EIRP threshold based on an antenna array architecture of the network entity. The diagram 700 shows different EIRPs of different subarrays of the network entity at different elevation angles. The network entity may be denoted as an aggressor node, due to the network entity potentially interfering with incumbent systems. The aggressor node may determine the EIRP_{avg}(θ₀) and EIRPₘₐₓ(θ₀) based on deployment or implementation aspects. The weighting factors [symbol] may be specified or provided a priori or may be based on a likelihood of usage determination in a deployment. An average over subarray architecture parameters may be a reasonable compromise for practical deployments than the worst-case option as it considers all possible options with weights rather than assume the worst-case subarray architecture parameter for deployment. The aggressor node may meet the limitation or threshold if EIRP_{avg}(θ₀)≤EIRP_{avg,allowed}(θ₀) and/or EIRPₘₐₓ(θ₀)≤EIRPₘₐₓ, allowed (θ₀). If the threshold is not met, then the aggressor node may employ measures to ensure compliance to the threshold, such as but not limited to power backoff, beam broadening which reduces EIRP along specific directions of victim nodes, antenna elements/subarray control, etc.

In some aspects, limitations specified for the aggressor node could be same or different from the use of a single subarray scenario. For example, if the limitations are different, there could be some other statistics or specifications in terms of what fraction of time EIRP_{avg}, allowed (θ₀) is allowed for a single subarray architecture vs. EIRP_{avg}, allowed (θ₀) for a multi-subarray architecture. In another example, if the limitations are the same, the aggressor node may meet the threshold for a single subarray architecture and provide statistics or specifications on how much of the threshold is exceeded with a multi-subarray architecture and how often the multi-subarray architecture is expected to be used relative to a single subarray architecture.

In some aspects, for conformance testing, different AAS architecture parameters may be tested against the proposed limitations and an acceptable or whitelist of AAS architecture/configuration parameters which may lead to meeting the threshold, and non-acceptable or a blacklist of AAS architecture/configuration parameters that may lead to exceeding the threshold could be made. For example, the comparison of the different AAS architecture parameters with the proposed limitations and the acceptable or whitelist of AAS architecture/configuration parameters that result in the different AAS architecture parameters exceeding the threshold could form or be added to the blacklist of AAS architecture/configuration parameters. The use of the non-acceptable or blacklisted AAS architecture parameters may be indicated via control signaling to a second network entity that checks for compliance. In some aspects, the second network entity that checks for compliance may be a component of or at the aggressor node. In some aspects, the second network entity that checks for compliance may be separate from the aggressor node. The network entity may maintain a time-average of use of the non-acceptable or blacklisted AAS architecture parameters and may be configured to take further action if that time-average exceeds the threshold (e.g., either a portion, absolute time, or relative time based at least on a time of day or victim node considerations).

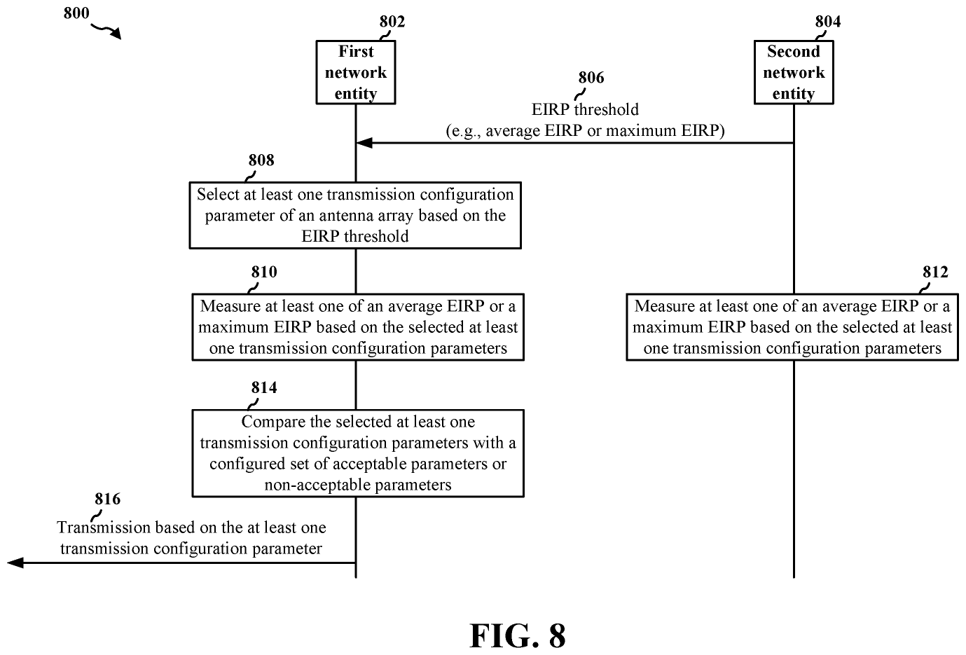

FIG. 8 is a call flow diagram 800 of signaling between a first network entity 802 and a second network entity 804. The first network entity 802 may be configured to provide at least one cell. For example, in the context of FIG. 1, the first network entity 802 may correspond to base station 102. In another example, in the context of FIG. 3, the first network entity 802 may correspond to base station 310. The second network entity 804 may be a device at or within the first network entity 802 or may be a separate device in communication with the first network entity.

At 806, the second network entity 804 may provide an EIRP threshold. The second network entity may provide the EIRP threshold to the first network entity 802. The first network entity 802 may obtain the EIRP threshold from the second network entity 804. The EIRP threshold may include one or more of an average EIRP over multiple subarray architecture parameters or a maximum EIRP for each of the multiple subarray architecture parameters.

At 808, the first network entity 802 may select at least one transmission configuration parameter of an antenna array. The first network entity may select the at least one transmission configuration parameter of the antenna array based on an EIRP threshold. In some aspects, the first network entity may be configured with the EIRP threshold or may receive the EIRP threshold from the second network entity. In some aspects, the first network entity may be configured with one or more transmission configuration parameters or may receive the one or more transmission configuration parameters. The EIRP threshold may include one or more of an average EIRP over multiple subarray architecture parameters or a maximum EIRP for each of the multiple subarray architecture parameters. In some aspects, the at least one transmission configuration parameters may comprise at least one of weighting factors for at least one antenna element within the antenna array, an azimuth sampling angle, a sampled single beamspace peak or multi-beam beamforming vectors, or subarray architecture parameters (e.g., a number of subarrays, electrical subarray tilting angles, etc.). One or more of the transmission configuration parameters may be adjusted based on the EIRP threshold. For example, one or more of the transmission configuration parameters may be adjusted to allow for an increase or a decrease of transmission from the first network entity based on the EIRP threshold for different elevation angles above the horizon. In some aspects, the at least one transmission configuration parameters of the antenna array may be adjusted in instances where a transmission exceeds the EIRP threshold. In some aspects, the EIRP threshold may be based on a period of time and a configuration of the antenna array. The configuration of the antenna array may comprise at least a single subarray configuration or a multiple subarray configuration. The EIRP threshold may indicate the period of time for an average EIRP allowed for a particular angle.

At 810, the first network entity 802 may measure at least one of an average EIRP or a maximum EIRP. The first network entity may measure at least one of the average EIRP or the maximum EIRP based on the selected at least one transmission configuration parameters. The first network entity may measure at least one of the average EIRP or the maximum EIRP of the first network entity based on the selected at least one transmission configuration parameters. In some aspects, measurement of at least one of the average EIRP or the maximum EIRP may be at one or more elevation angles above a reference plane. For example, the reference plane may comprise a plane above the horizon or the reference plane being at a configurable height above or in reference with the first network entity or a surface reference plane. In some aspects, a first angle associated with the average EIRP or a second angle associated with the maximum EIRP may be identified based at least on the measurement of at least one of the average EIRP or the maximum EIRP at the one or more elevation angles. In some aspects, transmissions of the first network entity are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

At 812, the second network entity 804 may measure at least one of an average EIRP or a maximum EIRP based on the selected at least one transmission configuration parameters. In some aspects, measurement of at least one of the average EIRP or the maximum EIRP is at one or more elevation angles above a reference plane. For example, the reference plane may comprise a plane above the horizon or the reference plane being at a configurable height above or in reference with the first network entity or a surface reference plane. In some aspects, a first angle associated with the average EIRP or a second angle associated with the maximum EIRP may be identified based at least on the measurement of at least one of the average EIRP or the maximum EIRP at the one or more elevation angles. In some aspects, transmissions of the first network entity are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

At 814, the first network entity 802 may compare the selected at least one transmission configuration parameters with a configured set of acceptable parameters or non-acceptable parameters. For example, the first network entity may compare the selected at least one transmission configuration parameters with a configured set of acceptable parameters or non-acceptable parameters to determine whether the selected at least one transmission configuration parameters conform to the EIRP threshold. The comparison of the selected at least one transmission configuration parameters with the configured set of acceptable parameters may be to determine or ensure that the selected at least one transmission configuration parameters are within the EIRP threshold. In addition, the comparison of the selected at least one transmission configuration parameters with the non-acceptable parameters may be to determine or ensure that the selected at least one transmission configuration parameters exceed the EIRP threshold or do not conform to the EIRP threshold. For example, the comparison of the selected at least one transmission configuration parameters and the configured set of acceptable parameters may result in the selected at least one transmission configuration parameters exceeding the EIRP threshold, as such, such at least one transmission configuration parameters could form or may be added to a listing of the non-acceptable parameters. In some aspects, the first network entity may maintain a time-average of use of the non-acceptable parameters and may be configured to take further action if that time-average exceeds the EIRP threshold (e.g., either a portion, absolute time, or relative time based at least on a time of day or victim node considerations).

At 816, the first network entity 802 may transmit based on the at least one transmission configuration parameter. The first network entity may transmit transmissions to one or more UEs (not shown) based on the at least one transmission configuration parameter.

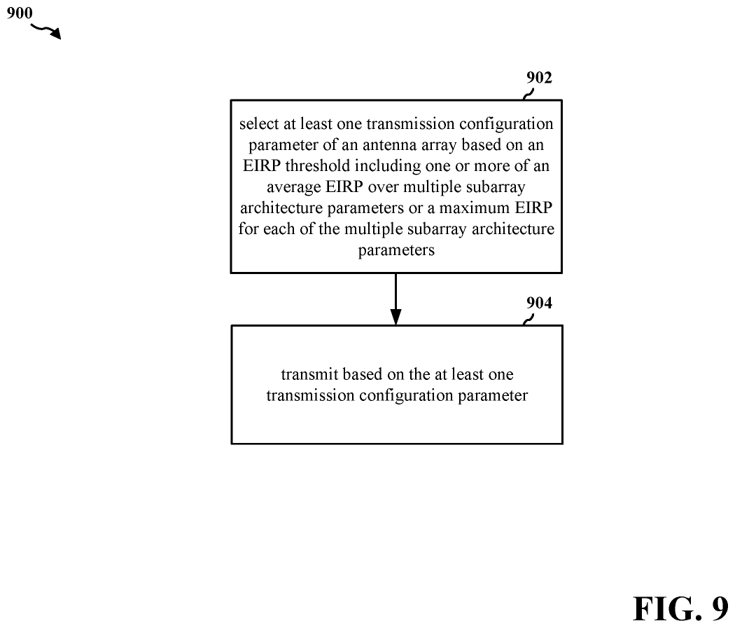

FIG. 9 is a flowchart 900 of a method of wireless communication. The method may be performed by a base station (e.g., the base station 102; the network entity 1102). One or more of the illustrated operations may be omitted, transposed, or contemporaneous. The method may configure transmission properties of a first network entity based on an antenna array architecture of the first network entity.

At 902, the first network entity may select at least one transmission configuration parameter of an antenna array. For example, 902 may be performed by parameter component 199 of network entity 1102. The first network entity may select the at least one transmission configuration parameter of the antenna array based on an EIRP threshold. The EIRP threshold may include one or more of an average EIRP over multiple subarray architecture parameters or a maximum EIRP for each of the multiple subarray architecture parameters. In some aspects, the at least one transmission configuration parameters may comprise weighting factors for at least one antenna element within the antenna array. In some aspects, the at least one transmission configuration parameters of the antenna array may be adjusted in instances where a transmission exceeds the EIRP threshold. In some aspects, the EIRP threshold may be based on a period of time and a configuration of the antenna array. The configuration of the antenna array may comprise at least a single subarray configuration or a multiple subarray configuration. The EIRP threshold may indicate the period of time for an average EIRP allowed for a particular angle.

At 904, the first network entity may transmit transmissions based on the at least one transmission configuration parameter. For example, 904 may be performed by parameter component 199 of network entity 1102. The first network entity may transmit the transmissions to one or more UEs based on the at least one transmission configuration parameter.

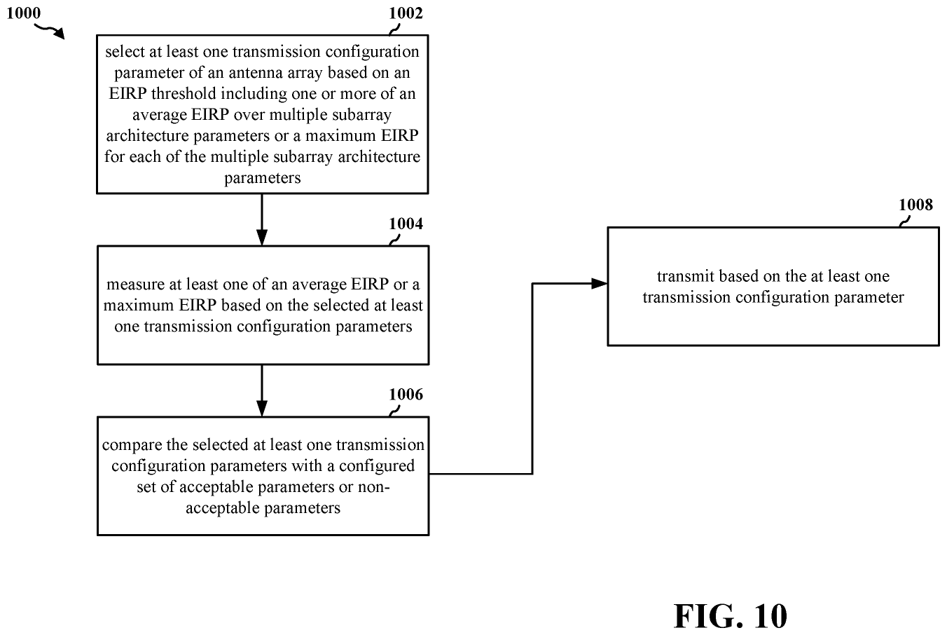

FIG. 10 is a flowchart 1000 of a method of wireless communication. The method may be performed by a base station (e.g., the base station 102; the network entity 1102). One or more of the illustrated operations may be omitted, transposed, or contemporaneous. The method may configure transmission properties of a first network entity based on an antenna array architecture of the first network entity.

At 1002, the first network entity may select at least one transmission configuration parameter of an antenna array. For example, 1002 may be performed by parameter component 199 of network entity 1102. The first network entity may select the at least one transmission configuration parameter of the antenna array based on an EIRP threshold. The EIRP threshold may include one or more of an average EIRP over multiple subarray architecture parameters or a maximum EIRP for each of the multiple subarray architecture parameters. In some aspects, the at least one transmission configuration parameters may comprise weighting factors for at least one antenna element within the antenna array. In some aspects, the at least one transmission configuration parameters of the antenna array may be adjusted in instances where a transmission exceeds the EIRP threshold. In some aspects, the EIRP threshold may be based on a period of time and a configuration of the antenna array. The configuration of the antenna array may comprise at least a single subarray configuration or a multiple subarray configuration. The EIRP threshold may indicate the period of time for an average EIRP allowed for a particular angle.

At 1004, the first network entity may measure at least one of an average EIRP or a maximum EIRP. For example, 1004 may be performed by parameter component 199 of network entity 1102. The first network entity may measure at least one of the average EIRP or the maximum EIRP based on the selected at least one transmission configuration parameters. In some aspects, measurement of at least one of the average EIRP or the maximum EIRP may be at one or more elevation angles above a reference plane. For example, the reference plane may comprise a plane above the horizon or the reference plane being at a configurable height above the first network entity or a surface reference plane. In some aspects, a first angle associated with the average EIRP or a second angle associated with the maximum EIRP may be identified based at least on the measurement of at least one of the average EIRP or the maximum EIRP at the one or more elevation angles. In some aspects, transmissions of the first network entity are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

At 1006, the first network entity may compare the selected at least one transmission configuration parameters with a configured set of acceptable parameters or non-acceptable parameters. For example, 1006 may be performed by parameter component 199 of network entity 1102.

At 1008, the first network entity may transmit transmissions based on the at least one transmission configuration parameter. For example, 1008 may be performed by parameter component 199 of network entity 1102. The first network entity may transmit the transmissions to one or more UEs based on the at least one transmission configuration parameter.

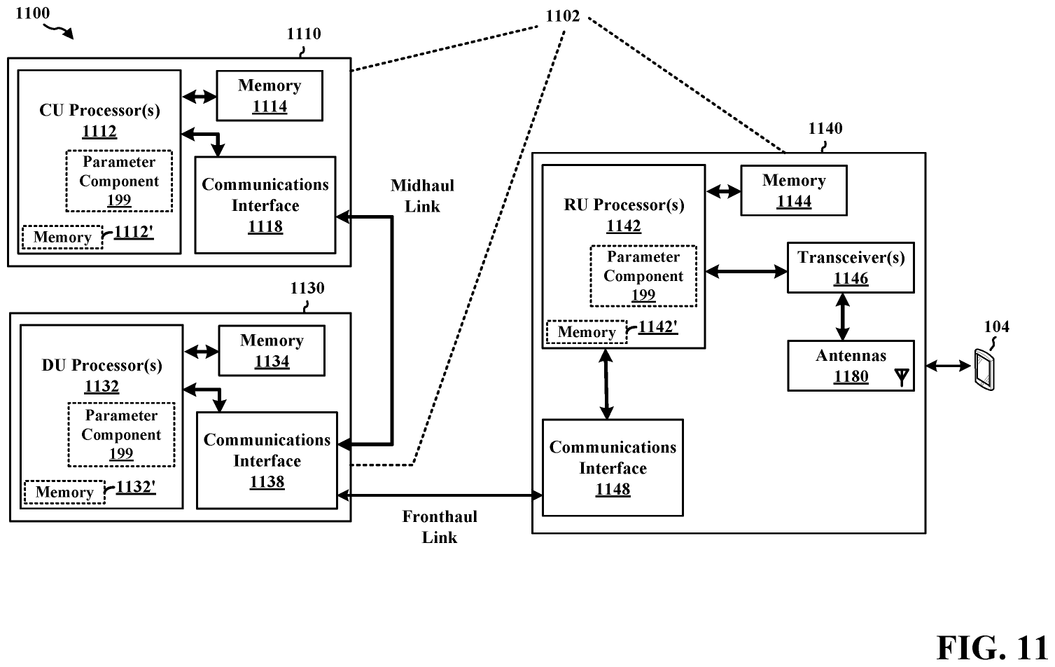

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to select at least one transmission configuration parameter of an antenna array based on an EIRP threshold including one or more of an average EIRP over multiple subarray architecture parameters or a maximum EIRP for each of the multiple subarray architecture parameters; and transmit based on the at least one transmission configuration parameter. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for selecting at least one transmission configuration parameter of an antenna array based on an EIRP threshold including one or more of an average EIRP over multiple subarray architecture parameters or a maximum EIRP for each of the multiple subarray architecture parameters. The network entity includes means for transmitting based on the at least one transmission configuration parameter. The network entity further includes means for measuring at least one of an average EIRP or a maximum EIRP based on the selected at least one transmission configuration parameters. The network entity further includes means for comparing the selected at least one transmission configuration parameters with a configured set of acceptable parameters or non-acceptable parameters. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

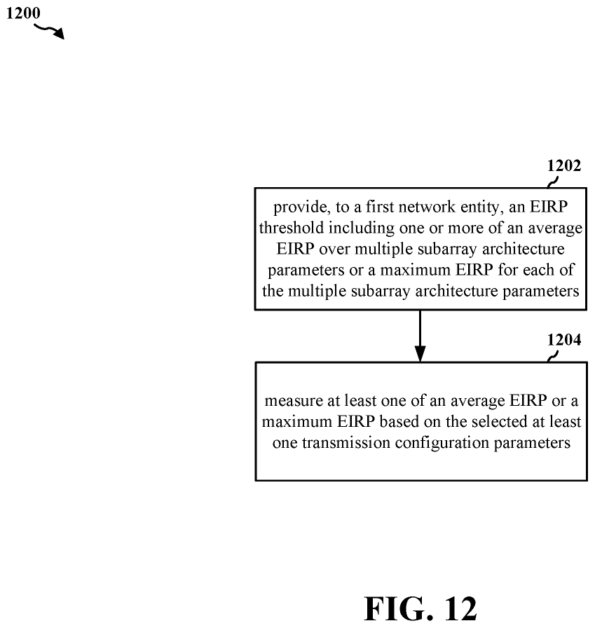

FIG. 12 is a flowchart 1200 of a method of wireless communication. The method may be performed by a base station (e.g., the base station 102; the network entity 1302). One or more of the illustrated operations may be omitted, transposed, or contemporaneous. The method may provide a configuration of transmission properties for a first network entity based on an antenna array architecture of the first network entity.

At 1202, the second network entity may provide an EIRP threshold. For example, 1202 may be performed by parameter component 199 of network entity 1302. The second network entity may provide the EIRP threshold to a first network entity. The EIRP threshold may include one or more of an average EIRP over multiple subarray architecture parameters or a maximum EIRP for each of the multiple subarray architecture parameters.

At 1204, the second network entity may measure at least one of an average EIRP or a maximum EIRP. For example, 1204 may be performed by parameter component 199 of network entity 1302. The second network entity may measure at least one of the average EIRP or the maximum EIRP based on the selected at least one transmission configuration parameters. In some aspects, measurement of at least one of the average EIRP or the maximum EIRP is at one or more elevation angles above a reference plane. For example, the reference plane may comprise a reference plane above the horizon or the reference plane being at a configurable height above the first network entity or a surface reference plane. In some aspects, a first angle associated with the average EIRP or a second angle associated with the maximum EIRP may be identified based at least on the measurement of at least one of the average EIRP or the maximum EIRP at the one or more elevation angles. In some aspects, transmissions of the first network entity are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

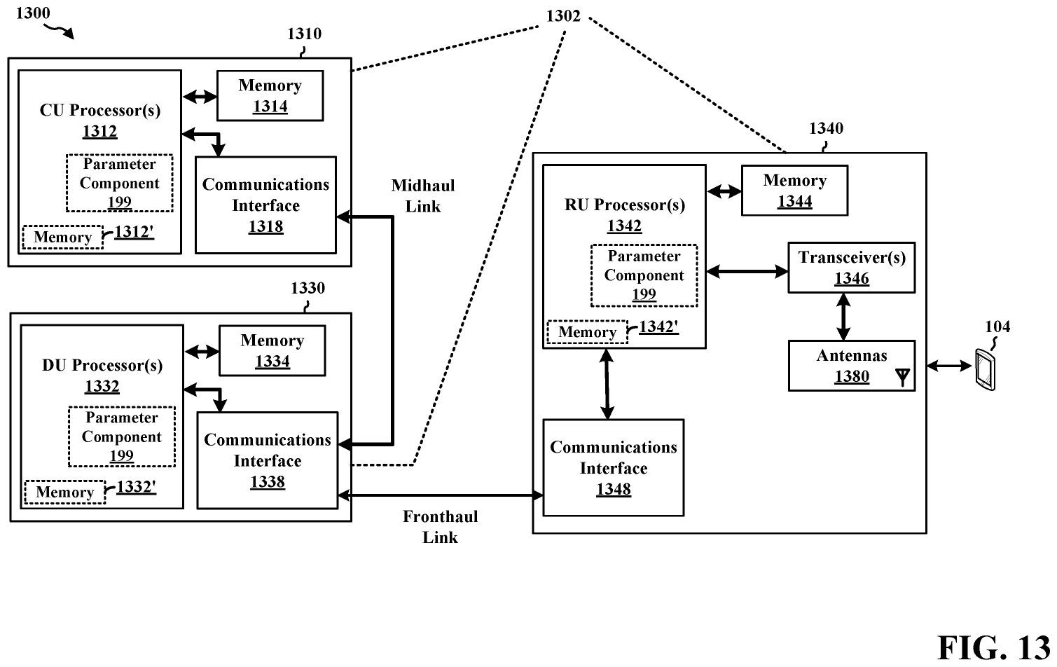

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, to a first network entity, an EIRP threshold including one or more of an average EIRP over multiple subarray architecture parameters or a maximum EIRP for each of the multiple subarray architecture parameters; and measure at least one of an average EIRP or a maximum EIRP based on the selected at least one transmission configuration parameters. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for providing, to a first network entity, an EIRP threshold including one or more of an average EIRP over multiple subarray architecture parameters or a maximum EIRP for each of the multiple subarray architecture parameters. The network entity includes means for measuring at least one of an average EIRP or a maximum EIRP based on the selected at least one transmission configuration parameters. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network entity, comprising selecting at least one transmission configuration parameter of an antenna array based on an EIRP threshold including one or more of an average EIRP over multiple subarray architecture parameters or a maximum EIRP for each of the multiple subarray architecture parameters; and transmitting based on the at least one transmission configuration parameter.

Aspect 2 is the method of aspect 1, further including measuring at least one of the average EIRP or the maximum EIRP based on the selected at least one transmission configuration parameters.

Aspect 3 is the method of any of aspects 1 and 2, further includes that measurement of at least one of the average EIRP or the maximum EIRP is at one or more elevation angles above a reference plane.

Aspect 4 is the method of any of aspects 1-3, further includes that a first angle associated with the average EIRP or a second angle associated with the maximum EIRP is identified based at least on the measurement of at least one of the average EIRP or the maximum EIRP at the one or more elevation angles.

Aspect 5 is the method of any of aspects 1-4, further includes that transmissions are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

Aspect 6 is the method of any of aspects 1-5, further includes that the at least one transmission configuration parameters comprise weighting factors for at least one antenna element within the antenna array.

Aspect 7 is the method of any of aspects 1-6, further includes that the at least one transmission configuration parameters of the antenna array are adjusted in instances where a transmission exceeds the EIRP threshold.

Aspect 8 is the method of any of aspects 1-7, further includes that the EIRP threshold is based on a period of time and a configuration of the antenna array.

Aspect 9 is the method of any of aspects 1-8, further includes that the configuration of the antenna array comprises at least a single subarray configuration or a multiple subarray configuration.

Aspect 10 is the method of any of aspects 1-9, further includes that the EIRP threshold indicates the period of time for the average EIRP allowed for a particular angle.

Aspect 11 is the method of any of aspects 1-10, further including comparing the selected at least one transmission configuration parameters with a configured set of acceptable parameters or non-acceptable parameters.

Aspect 12 is an apparatus for wireless communication at a first network entity including at least one processor coupled to a memory and at least one transceiver, the at least one processor configured to implement any of aspects 1-11.

Aspect 13 is an apparatus for wireless communication at a first network entity including means for implementing any of aspects 1-11.

Aspect 14 is a computer-readable medium storing computer executable code, where the code when executed by a processor causes the processor to implement any of aspects 1-11.

Aspect 15 is a method of wireless communication at a second network entity comprising providing, to a first network entity, an EIRP threshold including one or more of an average EIRP over multiple subarray architecture parameters or a maximum EIRP for each of the multiple subarray architecture parameters; and measuring at least one of the average EIRP or the maximum EIRP based on a selected at least one transmission configuration parameters.

Aspect 16 is the method of aspect 15, further includes that measurement of at least one of the average EIRP or the maximum EIRP is at one or more elevation angles above a reference plane.

Aspect 17 is the method of any of aspects 15 and 16, further includes that a first angle associated with the average EIRP or a second angle associated with the maximum EIRP is identified based at least on the measurement of at least one of the average EIRP or the maximum EIRP at the one or more elevation angles.

Aspect 18 is the method of any of aspects 15-17, further includes that transmissions are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

Aspect 19 is an apparatus for wireless communication at a second network entity including at least one processor coupled to a memory and at least one transceiver, the at least one processor configured to implement any of aspects 15-18.

Aspect 20 is an apparatus for wireless communication at a second network entity including means for implementing any of aspects 15-18.

Aspect 21 is a computer-readable medium storing computer executable code, where the code when executed by a processor causes the processor to implement any of aspects 15-18.

What is claimed is:

1. An apparatus for wireless communication at a first network entity, comprising:
at least one memory; and
at least one processor coupled to the at least one memory and, based at least in part on information stored in the at least one memory, the at least one processor, individually or in any combination, is configured to cause the apparatus to:
select at least one transmission configuration parameter of an antenna array based on an equivalent isotropic radiated power (EIRP) threshold including one or more of an average EIRP over multiple subarray architecture parameters or a maximum EIRP for each of the multiple subarray architecture parameters; and
transmit based on the at least one transmission configuration parameter.

2. The apparatus of claim 1, further comprising a transceiver coupled to the at least one processor, the transceiver being configured to:
transmit based on the at least one transmission configuration parameter.

3. The apparatus of claim 1, wherein the at least one processor is configured to:
measure at least one of the average EIRP or the maximum EIRP based on the selected at least one transmission configuration parameters.

4. The apparatus of claim 3, wherein measurement of at least one of the average EIRP or the maximum EIRP is at one or more elevation angles above a reference plane.

5. The apparatus of claim 4, wherein a first angle associated with the average EIRP or a second angle associated with the maximum EIRP is identified based at least on the measurement of at least one of the average EIRP or the maximum EIRP at the one or more elevation angles.

6. The apparatus of claim 5, wherein transmissions are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

7. The apparatus of claim 1, wherein the at least one transmission configuration parameters comprise weighting factors for at least one antenna element within the antenna array.

8. The apparatus of claim 1, wherein the at least one transmission configuration parameters of the antenna array are adjusted in instances where a transmission exceeds the EIRP threshold.

9. The apparatus of claim 1, wherein the EIRP threshold is based on a period of time and a configuration of the antenna array.

10. The apparatus of claim 9, wherein the configuration of the antenna array comprises at least a single subarray configuration or a multiple subarray configuration.

11. The apparatus of claim 10, wherein the EIRP threshold indicates the period of time for the average EIRP allowed for a particular angle.

12. The apparatus of claim 1, wherein the at least one processor is configured to:
compare the selected at least one transmission configuration parameters with a configured set of acceptable parameters or non-acceptable parameters.

13. A method of wireless communication at a first network entity, comprising:
selecting at least one transmission configuration parameter of an antenna array based on an equivalent isotropic radiated power (EIRP) threshold including one or more of an average EIRP over multiple subarray architecture parameters or a maximum EIRP for each of the multiple subarray architecture parameters; and
transmitting based on the at least one transmission configuration parameter.

14. The method of claim 13, further comprising:
measuring at least one of the average EIRP or the maximum EIRP based on the selected at least one transmission configuration parameters.

15. The method of claim 14, wherein measurement of at least one of the average EIRP or the maximum EIRP is at one or more elevation angles above a reference plane.

16. The method of claim 15, wherein a first angle associated with the average EIRP or a second angle associated with the maximum EIRP is identified based at least on the measurement of at least one of the average EIRP or the maximum EIRP at the one or more elevation angles.

17. The method of claim 16, wherein transmissions are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

18. The method of claim 13, wherein the at least one transmission configuration parameters comprise weighting factors for at least one antenna element within the antenna array.

19. The method of claim 13, wherein the at least one transmission configuration parameters of the antenna array are adjusted in instances where a transmission exceeds the EIRP threshold.

20. The method of claim 13, wherein the EIRP threshold is based on a period of time and a configuration of the antenna array.

21. The method of claim 20, wherein the configuration of the antenna array comprises at least a single subarray configuration or a multiple subarray configuration.

22. The method of claim 21, wherein the EIRP threshold indicates the period of time for the average EIRP allowed for a particular angle.

23. The method of claim 13, further comprising:
comparing the selected at least one transmission configuration parameters with a configured set of acceptable parameters or non-acceptable parameters.

24. An apparatus for wireless communication at a second network entity, comprising:
at least one memory; and
at least one processor coupled to the at least one memory and, based at least in part on information stored in the at least one memory, the at least one processor, individually or in any combination, is configured to cause the apparatus to:
provide, to a first network entity, an equivalent isotropic radiated power (EIRP) threshold including one or more of an average EIRP over multiple subarray architecture parameters or a maximum EIRP for each of the multiple subarray architecture parameters; and
measure at least one of the average EIRP or the maximum EIRP based on a selected at least one transmission configuration parameters.

25. The apparatus of claim 24, further comprising a transceiver coupled to the at least one processor, the transceiver being configured to:
provide, to the first network entity, the EIRP threshold including one or more of the average EIRP over the multiple subarray architecture parameters or the maximum EIRP for each of the multiple subarray architecture parameters.

26. The apparatus of claim 24, wherein measurement of at least one of the average EIRP or the maximum EIRP is at one or more elevation angles above a reference plane.

27. The apparatus of claim 26, wherein a first angle associated with the average EIRP or a second angle associated with the maximum EIRP is identified based at least on the measurement of at least one of the average EIRP or the maximum EIRP at the one or more elevation angles.

28. The apparatus of claim 27, wherein transmissions are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.

29. A method of wireless communication at a second network entity, comprising:
providing, to a first network entity, an equivalent isotropic radiated power (EIRP) threshold including one or more of an average EIRP over multiple subarray architecture parameters or a maximum EIRP for each of the multiple subarray architecture parameters; and
measuring at least one of the average EIRP or the maximum EIRP based on a selected at least one transmission configuration parameters.

30. The method of claim 29, wherein measurement of at least one of the average EIRP or the maximum EIRP is at one or more elevation angles above a reference plane, wherein a first angle associated with the average EIRP or a second angle associated with the maximum EIRP is identified based at least on the measurement of at least one of the average EIRP or the maximum EIRP at the one or more elevation angles, wherein transmissions are within the EIRP threshold if a first transmission at the first angle associated with the average EIRP is less than an allowed average EIRP for the first angle, or a second transmission at the second angle associated with the maximum EIRP is less than an allowed maximum EIRP for the second angle.
